(19) United States
(12) Patent Application Publication
(10) Pub. No.: US 2025/0036000 A1
(43) Pub. Date: Jan. 30, 2025

(54) ELECTROCHROMIC VARIABLE-TRANSMITTANCE GLASS AND PREPARATION METHOD

(71) Applicant: Furcifer Inc., Fremont, CA (US)

(72) Inventors: Zhao CHEN, Camarillo, CA (US); Yan ZHOU, Fremont, CA (US); Jian WANG, Fremont, CA (US); Zhimin FU, Yangzhou (CN); Miaozi LI, Yangzhou (CN); Yuanyuan ZHANG, Yangzhou (CN); Min TANG, Yangzhou (CN)

(21) Appl. No.: 18/473,657

(22) Filed: Sep. 25, 2023

(30) Foreign Application Priority Data
Jul. 28, 2023 (CN) 202310940170.7

(51) Int. Cl. G02F 1/153; G02F 1/155

(52) U.S. Cl. CPC G02F 1/1533; G02F 1/155; G02F 2001/1536; G02F 2001/1557

(57) ABSTRACT

This application describes an electrochromic variable-transmittance glass and its preparation method. An example electrochromic variable-transmittance glass includes an electrochromic variable-transmittance film device, glass, and laminating adhesive. Laminating adhesive is positioned on one side of each opposing surface of the two glass pieces. The electrochromic variable-transmittance film device is sandwiched between the two glass pieces and wrapped by the laminating adhesive. The electrochromic variable-transmittance film device comprises conductive tape electrodes, lead-out electrodes, and a protective layer. The conductive tape electrodes are situated on the conductive substrate of the electrochromic variable-transmittance film device. The lead-out electrodes are positioned on the conductive substrate or the conductive tape electrodes and are conductively connected with the conductive tape electrodes, extending to the outer side of the glass for connection to an external power source. The protective layer covers the conductive tape electrodes and seals them onto the conductive substrate.

### CROSS-REFERENCE TO RELATED APPLICATIONS

This application claims priority to Chinese Patent Application No. 202310940170.7, filed on Jul. 28, 2023. The entire content of the above-identified application is incorporated herein by reference.

### TECHNICAL FIELD

This application pertains to the field of electrochromic technology, specifically related to an electrochromic variable-transmittance glass and its preparation method.

### BACKGROUND

The use of glass is becoming increasingly widespread in both the automotive and construction industries. For safety reasons, most of the glass used is laminated glass. Laminated glass consists of two glass layers with an interlayer of adhesive in between. Through processes like pre-pressing and high-pressure autoclave bonding, the glass adheres tightly to the interlayer, maintaining its integrity and preventing shattering upon impact.

Meanwhile, electrochromic variable tint thin-film devices utilize the electrochromic effect. By applying a direct current voltage of around 1.5V at the electrodes, the device's light transmission can change by several times. When combined with laminated glass, these devices create electrochromic variable-transmittance glass. This glass is applied in the construction and automotive industries to regulate indoor or in-car lighting by adjusting light transmission through voltage or current, resulting in significant energy savings and improved human-machine efficiency. As a result, it holds immense potential for development.

However, when electrochromic variable tint thin-film devices are integrated with glass and adhesive through lamination processes, they often experience malfunction within a few days or weeks after lamination is complete.

### SUMMARY

The purpose of this application is to provide an electrochromic variable-transmittance glass and its preparation method to address the short-term failure issue of electrochromic variable-transmittance film devices in such glass, while keeping the cost low. Specific technical solutions are as follows:

This application provides an electrochromic variable-transmittance glass, comprising an electrochromic variable-transmittance film device, at least two pieces of glass, and laminating adhesive. the laminating adhesive is positioned on each opposing surface of the two pieces of glass. The electrochromic variable-transmittance film device is sandwiched between the two pieces of glass and wrapped by the laminating adhesive. The electrochromic variable-transmittance film device comprises a conductive tape electrode, a lead-out electrode, and a protective layer. The conductive tape electrode is positioned on a conductive substrate of the electrochromic variable-transmittance film device. The lead-out electrode is positioned on the conductive substrate or the conductive tape electrode, conductively connected with the conductive tape electrode, and extended out of the two pieces of glass for connection to an external power source. The protective layer covers and seals the conductive tape electrode onto the conductive substrate.

Through thorough research, the inventors of this application have discovered that by setting up conductive tape electrodes and a protective layer, the short-term failure issue of electrochromic variable-transmittance film devices in electrochromic variable-transmittance glass can be effectively resolved, while keeping the cost low.

This application provides a preparation method for the electrochromic variable-transmittance glass as described in any one of the above aspects. The method includes the following steps:
(1) placing the laminating adhesive on one side of each of the two pieces of glass;
(2) placing a conductive tape electrode on the conductive substrate of the electrochromic variable-transmittance film device, placing a lead-out electrode on the conductive substrate or the conductive tape electrode, and establishing conductive connection between the lead-out electrode and the conductive tape electrode;
(3) setting a protective layer on the conductive tape electrode, covering and sealing the conductive tape electrode onto the conductive substrate; and
(4) placing the electrochromic variable-transmittance film device with the protective layer between the two pieces of glass obtained in step (1), with the sides of the laminating adhesive opposing each other, and pressing the two pieces of glass obtained in step (1) to obtain the electrochromic variable-transmittance glass, wherein the lead-out electrode extends out of the two pieces of glass.

In some embodiments, the protective layer is selected from at least one of protective film and protective adhesive, the protective film being one of polyethylene terephthalate film, polyimide film, polypropylene film, polyethylene film, or epoxy resin film, and the protective adhesive being one of epoxy resin, UV-curable adhesive, two-component mixed-curing adhesive, conductive silver adhesive, or conductive copper adhesive.

In some embodiments, the protective layer is selected from at least one of protective film and protective adhesive, the protective film being one of polyethylene terephthalate film, polyimide film, polypropylene film, polyethylene film, or epoxy resin film, and the protective adhesive being one of epoxy resin, UV-curable adhesive, two-component mixed-curing adhesive, conductive silver adhesive, or conductive copper adhesive.

In some embodiments, the thickness of the protective layer is between 10 micrometers to 1000 micrometers.

In some embodiments, at least one end of the conductive tape electrode includes conductive glue.

In some embodiments, the protective layer is selected from protective film or protective adhesive, where the protective adhesive covers and seals the conductive tape electrodes an onto the conductive substrate, and the protective film covers the protective adhesive.

In some embodiments, the electrochromic variable-transmittance film device is sandwiched between conductive substrates on both upper and lower sides, the protective film extending between the conductive substrates and the laminating adhesive, and covering portions of the upper and lower sides of the conductive substrate.

The electrochromic variable-transmittance glass and its preparation method described in this application has multiple technical improvements over existing technologies. The electrochromic variable-transmittance glass comprises an electrochromic variable-transmittance film device, glass, and laminating adhesive. Laminating adhesive is positioned on one side of each opposing surface of the two glass pieces. The electrochromic variable-transmittance film device is sandwiched between the two glass pieces and wrapped by the laminating adhesive. The electrochromic variable-transmittance film device comprises conductive tape electrodes, lead-out electrodes, and a protective layer. The conductive tape electrodes are situated on the conductive substrate of the electrochromic variable-transmittance film device. The lead-out electrodes are positioned on the conductive substrate or the conductive tape electrodes and are conductively connected with the conductive tape electrodes, extending to the outer side of the glass for connection to an external power source. The protective layer covers the conductive tape electrodes and seals them onto the conductive substrate. This configuration and manufacturing process effectively address the short-term failure issue of electrochromic variable-transmittance film devices in electrochromic variable-transmittance glass through the setup of conductive tape electrodes and a protective layer, while keeping the cost low.

Please note that any product or method embodying the principles of this application does not necessarily need to achieve all the advantages described above simultaneously.

### BRIEF DESCRIPTION OF THE DRAWINGS

To provide a clearer understanding of the technical solutions in the present application and the prior art, a brief introduction to the figures used in the embodiments or descriptions of the prior art is given below. It is evident that the figures described below are just a few examples of the embodiments of this application. Those skilled in the art can derive additional embodiments based on these figures.

FIG. 1 illustrates a disassembled structural schematic of the first embodiment of the present application.

FIG. 2 illustrates a disassembled structural schematic of the second embodiment of the present application.

FIG. 3 illustrates a disassembled structural schematic of the third embodiment of the present application.

FIG. 4 illustrates a disassembled structural schematic of the fourth embodiment of the present application.

FIG. 5 illustrates a disassembled structural schematic of the fifth embodiment of the present application.

FIG. 6 illustrates a disassembled structural schematic of the sixth embodiment of the present application.

FIG. 7 illustrates a top view schematic of the electrochromic variable-transmittance film device structure of the first embodiment of the present application.

Diagram Labels: 1: Glass; 2: Laminating Adhesive; 3: Conductive Substrate; 4: Conductive Adhesive; 5: Metal Film; 6: Electrochromic Light Modulating Film Device; 7: Protective Layer; 8: Lead-out Electrode.

### DETAIL DESCRIPTION OF THE EMBODIMENTS

Hereinafter, with reference to the figures in the embodiments of this application, the technical solutions in the embodiments of this application are described clearly and completely. It is evident that the embodiments described are only a part of the embodiments of this application, rather than all of them. Those skilled in the art can derive additional embodiments based on all the other embodiments obtained from this application.

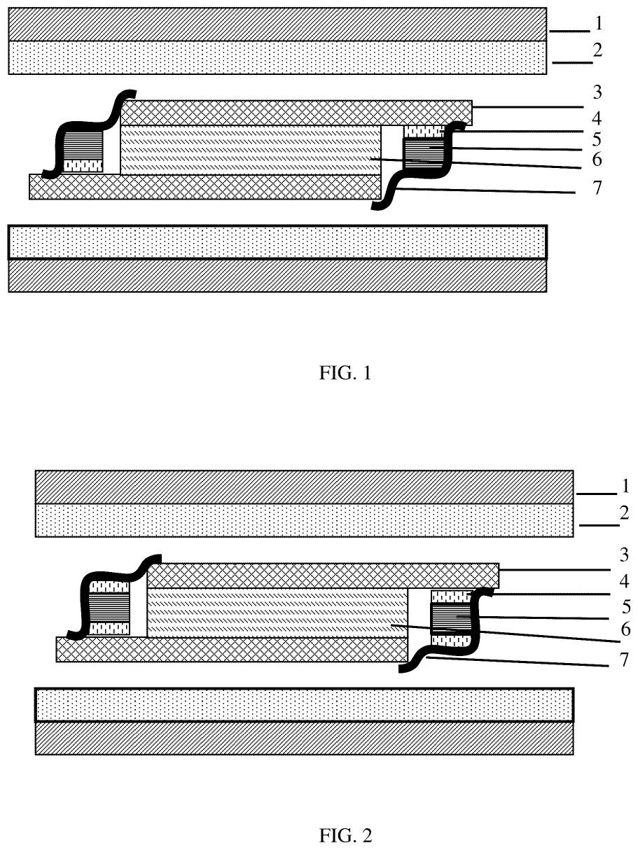

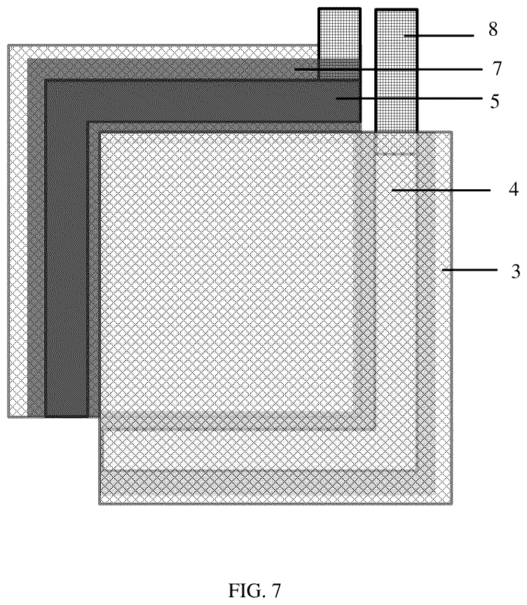

With reference to FIGS. 1 and 7, the first aspect of the present application provides an electrochromic variable-transmittance glass, comprising an electrochromic variable-transmittance film device 6, glass 1, and laminating adhesive 2. On one side of each opposing surface of the two glass pieces 1, laminating adhesive 2 is applied. The electrochromic variable-transmittance film device 6 is sandwiched between the two glass pieces 1 and enclosed by the laminating adhesive 2. The electrochromic variable-transmittance film device 6 comprises conductive tape electrodes, lead-out electrodes 8, and a protective layer 7. The conductive tape electrodes are situated on the conductive substrate 3 of the electrochromic variable-transmittance film device 6. The lead-out electrodes 8 are placed on the conductive substrate 3 or the conductive tape electrodes and are conductively connected with the conductive tape electrodes, extending to the outer side of the glass 1 to be connected to an external power source. The protective layer 7 covers the conductive tape electrodes and seals them onto the conductive substrate 3.

In existing technology, electrochromic variable-transmittance film devices often fail a few days or weeks after being laminated onto glass and laminating adhesive through a pressing process. To address this problem, protective films or adhesive are often used to tightly encapsulate the electrochromic variable-transmittance film devices. However, when electrochromic variable-transmittance glass is applied in industries such as automobiles and construction, it often features a large area, making the protective encapsulation process complex, time-consuming, and costly. Moreover, until now, professionals in this field were not clear about the failure sites and mechanisms of electrochromic variable-transmittance film devices.

Through in-depth research, the inventors of this application discovered that the normal operation of electrochromic variable-transmittance film devices requires an external power source, and the surface resistance of the conductive substrate of the electrochromic variable-transmittance film device is higher than that of metals like copper. To increase current injection efficiency and enhance coloration speed, larger contact area between the external power source and the conductive substrate of the electrochromic variable-transmittance film device is preferable. Bonding conductive tape onto the conductive substrate achieves a larger contact area, satisfying the requirements for driving the electrochromic variable-transmittance film device. Therefore, in electrochromic variable-transmittance glass, conductive tape can be used as the electrode to connect the electrochromic variable-transmittance film device and the lead-out electrode, which further connects to the external power source. At the same time, to make the laminating adhesive soft and easy to process, plasticizers and additives are often introduced in the preparation process. These plasticizers, additives, and external water and oxygen can infiltrate the electrochromic variable-transmittance film device, react with the conductive adhesive in the conductive tape electrode, leading to decreased conductivity of the conductive tape electrode, causing failure of the electrochromic variable-transmittance film device. By setting up a protective layer (7) on the conductive tape electrode, sealing the conductive tape electrode onto the conductive substrate (3), the plasticizers, additives, and external water and oxygen in the laminating adhesive (2) cannot diffuse into the conductive tape electrode. Thus, the short-term failure issue of electrochromic variable-transmittance film devices in electrochromic variable-transmittance glass is effectively resolved. Compared to the tightly encapsulated electrochromic variable-transmittance film devices in the existing technology, the cost is reduced. In this application, short-term failure refers to a significant decrease in working current and a noticeable decrease in coloration speed of the electrochromic variable-transmittance film device within 1 to 7 days after lamination completion, rendering it unable to maintain normal operation.

This application does not impose specific limitations on the type of lead-out electrode 8, as long as it achieves the objectives of this application. For instance, the lead-out electrode 8 can include, but is not limited to, one of the following: metal-coated wires or a flexible electrode. The flexible electrode 8 can be made of copper, aluminum, silver, or their combinations, and can be coated with a polymer on the outer side.

This application does not impose specific limitations on the type of laminating adhesive 2, as long as it achieves the objectives of this application. For example, the laminating adhesive 2 can include, but is not limited to, one of the following: polyvinyl butyral (PVB), ethylene-vinyl acetate copolymer (EVA), ionomer interlayer (Sentry Glas), or polyurethane (PU). Preferably, the laminating adhesive 2 is selected from PVB.

In some embodiments of this application, the protective layer 7 can be selected from at least one of protective films and protective adhesives. For example, the protective layer 7 can be selected from one of protective films and protective adhesives, or from both. The protective film can be made of one of the following: polyethylene terephthalate (PET), polyimide (PI), polypropylene (PP), polyethylene (PE), or epoxy resin (epoxy). The protective adhesive can be selected from one of the following: epoxy resin (epoxy), ultraviolet curing adhesive (UV adhesive), two-component curing adhesive (AB adhesive), conductive silver adhesive, or conductive copper adhesive.

In some embodiments of this application, the thickness of the protective layer 7 ranges from 10 micrometers to 1000 micrometers. For example, the thickness of the protective layer 7 can be 10 micrometers, 50 micrometers, 100 micrometers, 200 micrometers, 500 micrometers, 1000 micrometers, or any range in between. Controlling the thickness of the protective layer 7 within the scope of this application is advantageous in protecting the conductive tape electrode, preventing short-term failure of the electrochromic variable-transmittance film device 6, and saving costs by avoiding material wastage. This is beneficial for addressing the short-term failure issue of electrochromic variable-transmittance film devices in electrochromic variable-transmittance glass with lower costs.

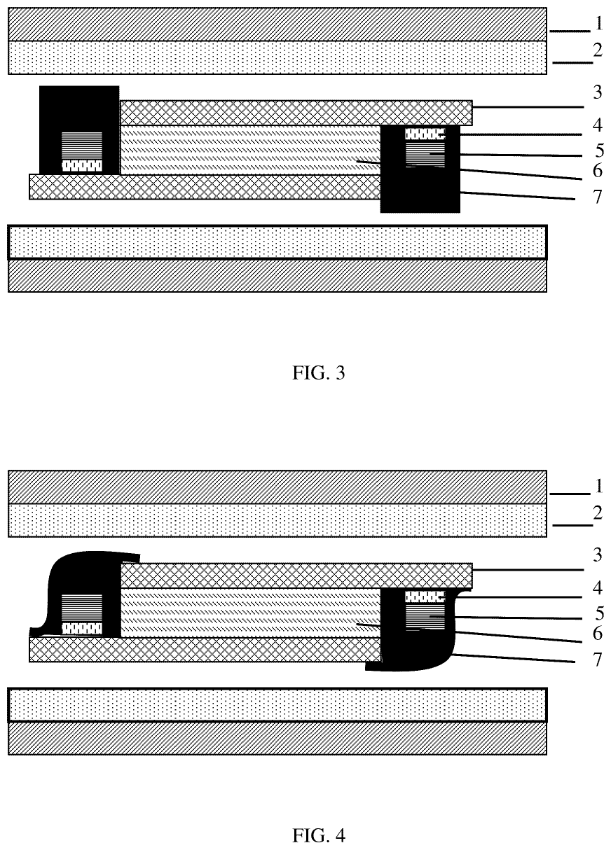

The conductive tape electrode can serve as an electrode for the electrochromic variable-transmittance film device. It is composed of a metal film 5 and one or multiple layers of conductive adhesive 4. Bonding the conductive tape onto the parts requiring conductivity enables convenient injection of current and voltage. Referring to FIGS. 1 to 6, in some embodiments of this application, at least one side of the conductive tape electrode includes conductive adhesive 4. The arrangement of conductive adhesive 4 in the conductive tape electrode can be in one of the following three ways: one side of the conductive tape electrode, which contacts the conductive substrate 3 of the electrochromic variable-transmittance film device 6, includes conductive adhesive 4, while the opposite side does not include adhesive; both sides of the conductive tape electrode, which contacts the conductive substrate 3 of the electrochromic variable-transmittance film device 6 and the opposite side, include conductive adhesive 4; one side of the conductive tape electrode, which contacts the conductive substrate 3 of the electrochromic variable-transmittance film device 6, includes conductive adhesive 4, while the opposite side includes non-conductive adhesive. Including conductive adhesive 4 on one side of the conductive tape electrode facilitates bonding to the electrochromic variable-transmittance film device 6, while including conductive adhesive 4 or non-conductive adhesive on the opposite side aids in securing the material covering the top of the conductive tape electrode, facilitating the preparation and packaging of electrochromic variable-transmittance glass in this application.

This application does not impose specific limitations on the type of conductive adhesive 4, as long as it achieves the objectives of this application. For example, conductive adhesive 4 can include, but is not limited to, one of the following: acrylic pressure-sensitive conductive adhesive, or conductive adhesive made by mixing conductive fillers with a matrix of polyimide, phenolic resin, or polyurethane.

In this application, the conductive tape electrode also includes a metal film 5. The type of metal in the metal film 5 is not specifically limited in this application, as long as it achieves the objectives of this application. For example, the metal can include, but is not limited to, at least one of copper, aluminum, or silver.

Referring to FIG. 4, in some embodiments of this application, the protective layer 7 is selected from protective films and protective adhesives. The protective adhesive covers the conductive tape electrode and seals it onto the conductive substrate 3, while the protective film covers the protective adhesive. Together, the protective adhesive and protective film form the protective layer 7.

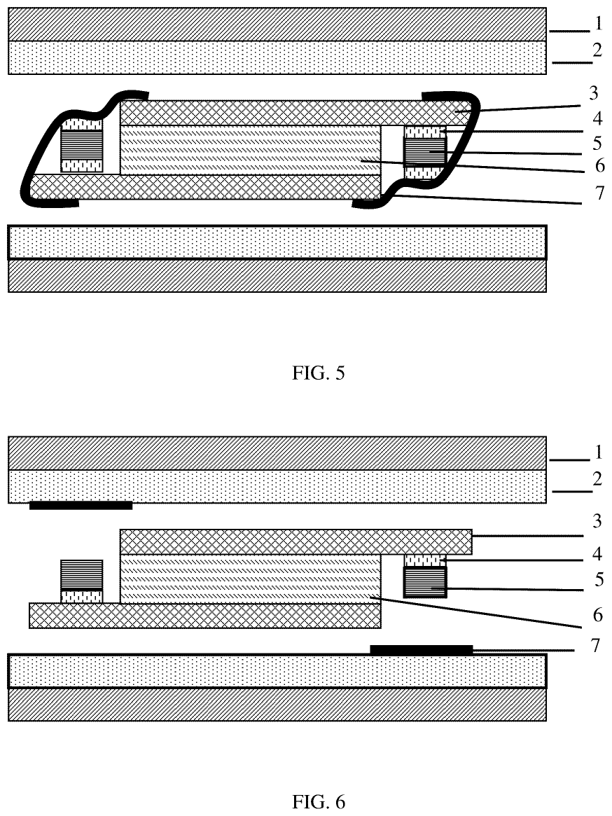

Referring to FIG. 5, in some embodiments of this application, the upper and lower sides of the electrochromic variable-transmittance film device 6 are equipped with conductive substrates 3, and the protective film extends to the space between the conductive substrates 3 and the laminating adhesive 2, simultaneously covering parts of the upper and lower conductive substrates 3. This structure helps to address the short-term failure issue of electrochromic variable-transmittance film devices in electrochromic variable-transmittance glass with irregular edges.

This application does not impose specific limitations on the type and structure of the electrochromic variable-transmittance film device 6, as long as it achieves the objectives of this application. For example, the electrochromic variable-transmittance film device 6 can include, but is not limited to, one of the following: transparent conductive layer, charge storage layer, electrolyte layer, and electrochromic layer.

The second aspect of this application provides a method for preparing electrochromic variable-transmittance glass from any of the above-mentioned embodiments. The method includes the following steps:

Step (1): Place the laminating adhesive 2 on one side of the glass 1. In some embodiments, the laminating adhesive 2 may also be placed on one side of the glass on the other end of the glass (e.g., the bottom glass in FIG. 5).

Step (2): Set the conductive tape electrode on the conductive substrate 3 of the electrochromic variable-transmittance film device 6. Place lead-out electrodes on the conductive substrate 3 or the conductive tape electrode, with the lead-out electrode connected to the conductive tape electrode.

Step (3): Apply the protective layer 7 onto the conductive tape electrode, covering it and sealing the conductive tape electrode onto the conductive substrate 3.

Step (4): Place the electrochromic variable-transmittance film device 6 with the protective layer 7 between the two pieces of glass (e.g., top glass 1 and the bottom glass) obtained from step 1. Position the laminating adhesive 2 on the sides of the electrochromic variable-transmittance film device 6, with the lead-out electrode extending to the outside of the glass. Perform a pressing process to obtain electrochromic variable-transmittance glass.

In some embodiments of this application, the protective layer 7 is selected from protective films and is directly set on the conductive tape electrode.

In some embodiments of this application, the protective layer 7 is selected from protective films. Conductive adhesive 4 is set on both sides of the conductive tape electrode, and the protective film is pre-fixed to the conductive tape electrode. This pre-fixing of the protective film can save preparation steps. This is beneficial for addressing the short-term failure issue of the electrochromic variable-transmittance film devices in electrochromic variable-transmittance glass with lower costs.

In some embodiments of this application, the protective layer 7 is selected from protective adhesives. The protective adhesive is applied in a dot pattern to cover the conductive tape electrode and seal it onto the conductive substrate 3. Using protective adhesive can enhance efficiency when it's inconvenient to set protective film or when the conductive tape electrode isn't linear. After curing, the protective adhesive forms the protective layer 7 to prevent plasticizers, additives, and water and oxygen diffusion from the laminating adhesive 2 and external environment from reaching the conductive tape electrode. When conductive silver adhesive or conductive copper adhesive is used for the protective adhesive, it can not only protect the conductive tape electrode but also enhance conductivity. This is beneficial for addressing the short-term failure issue of electrochromic variable-transmittance film devices in electrochromic variable-transmittance glass with lower costs.

In some embodiments of this application, the protective layer 7 is selected from protective adhesives and protective films. The protective adhesive is applied in a dot pattern to cover the conductive tape electrode and seal it onto the conductive substrate 3. The protective film is then applied over the protective adhesive. After curing, the protective adhesive and protective film together form the protective layer 7 to prevent plasticizers, additives, and water and oxygen diffusion from the laminating adhesive 2 and external environment from reaching the conductive tape electrode. This is beneficial for addressing the short-term failure issue of electrochromic variable-transmittance film devices in electrochromic variable-transmittance glass with lower costs.

In some embodiments of this application, the protective layer 7 is selected from protective films. The protective film is pre-fixed onto the side of the two pieces of glass 1 that is opposite to the side with the laminating adhesive 2, corresponding to the position of the conductive tape electrode. This pre-fixing of the protective film can enhance efficiency in the lamination process. This is beneficial for addressing the short-term failure issue of electrochromic variable-transmittance film devices in electrochromic variable-transmittance glass with lower costs.

This application does not impose specific limitations on the preparation of the electrochromic variable-transmittance film device 6, as long as it achieves the objectives of this application. For example, the preparation of the electrochromic variable-transmittance film device can include the preparation of a transparent conductive layer, charge storage layer, electrolyte layer, and electrochromic layer.

### EMBODIMENTS

Below, Embodiments and comparative Embodiments are provided to further illustrate the embodiments of this application more specifically. Various tests and evaluations are conducted as per the following methods. Unless otherwise specified, “parts” and “%” are based on mass.

### Testing Methods and Equipment:

### Coloration Time Test:

The electrochromic variable-transmittance glass is placed between a light source and a photodiode, and the current of the photodiode is recorded. This current is proportional to the light intensity passing through the electrochromic variable-transmittance glass. The lead-out electrode is connected to an external 1.5V power source. The transmittance of the electrochromic variable-transmittance film device starts changing, and the current change curve of the photodiode with time is recorded. The time from the start of the current change to stabilization is recorded as the coloration time. The initial coloration time is recorded once the electrochromic variable-transmittance film device is completed. Then, it is placed in a 110° C. oven for accelerated aging, and the coloration times are recorded after 7 days and 30 days of aging.

### Embodiment 1

Place the laminating adhesive on one side of the glass. Set the conductive tape electrode and lead-out electrode on the conductive substrate of the electrochromic variable-transmittance film device, with the lead-out electrode connected to the conductive tape electrode. Apply a conductive adhesive on one side of the conductive tape electrode that contacts the conductive substrate. Cut a 50 μm thick PET film slightly larger than the size of the conductive tape electrode. Place the PET film on the conductive tape electrode and seal it onto the conductive substrate. Place the electrochromic variable-transmittance film device with the protective layer between the two glass pieces obtained from step 1. The laminating adhesive is positioned on the sides of the electrochromic variable-transmittance film device, and the lead-out electrode extends to the outside of the glass. Perform a pressing process to obtain electrochromic variable-transmittance glass.

### Embodiment 2

Place the laminating adhesive on one side of the glass. Set the lead-out electrode on the conductive substrate of the electrochromic variable-transmittance film device. Cut a 50 μm thick PET film slightly larger than the size of the conductive tape electrode. Fix the PET film to one side of the conductive tape electrode that has conductive adhesive on both sides. Paste the conductive tape electrode onto the conductive substrate of the electrochromic variable-transmittance film device and seal the conductive tape electrode onto the conductive substrate with the PET film, ensuring the lead-out electrode is connected to the conductive tape electrode. Place the electrochromic variable-transmittance film device with the protective layer between the two glass pieces obtained from step 1. The laminating adhesive is positioned on the sides of the electrochromic variable-transmittance film device, and the lead-out electrode extends to the outside of the glass. Perform a pressing process to obtain electrochromic variable-transmittance glass.

### Embodiment 3

Place the laminating adhesive on one side of the glass. Set the conductive tape electrode and lead-out electrode on the conductive substrate of the electrochromic variable-transmittance film device, with the lead-out electrode connected to the conductive tape electrode. Apply epoxy resin protective adhesive in a dot pattern to seal the conductive tape electrode onto the conductive substrate. After curing, the protective layer has a thickness of 100 μm. Place the electrochromic variable-transmittance film device with the protective layer between the two glass pieces obtained from step 1. The laminating adhesive is positioned on the sides of the electrochromic variable-transmittance film device, and the lead-out electrode extends to the outside of the glass. Perform a pressing process to obtain electrochromic variable-transmittance glass.

### Embodiment 4

Place the laminating adhesive on one side of the glass. Set the conductive tape electrode and lead-out electrode on the conductive substrate of the electrochromic variable-transmittance film device, with the lead-out electrode connected to the conductive tape electrode. Apply a conductive adhesive on one side of the conductive tape electrode that contacts the conductive substrate. Cut a 50 μm thick PET film slightly larger than the size of the conductive tape electrode. Apply epoxy resin protective adhesive in a dot pattern to seal the conductive tape electrode onto the conductive substrate. Place the PET film over the epoxy resin protective adhesive. After curing, the protective layer has a thickness of 150 μm. Place the electrochromic variable-transmittance film device with the protective layer between the two glass pieces obtained from step 1. The laminating adhesive is positioned on the sides of the electrochromic variable-transmittance film device, and the lead-out electrode extends to the outside of the glass. Perform a pressing process to obtain electrochromic variable-transmittance glass.

### Embodiment 5

Place the laminating adhesive on one side of the glass. Set the conductive tape electrode and lead-out electrode on the conductive substrate of the electrochromic variable-transmittance film device, with the lead-out electrode connected to the conductive tape electrode. Both the side of the conductive tape electrode that contacts the conductive substrate and the opposite side are equipped with conductive adhesive. Cut a 50 μm thick PET film slightly larger than the size of the conductive tape electrode. Place the PET film on the conductive tape electrode and seal it onto the conductive substrate of the electrochromic variable-transmittance film device. Place the electrochromic variable-transmittance film device with the protective layer between the two glass pieces obtained from step 1. The laminating adhesive is positioned on the sides of the electrochromic variable-transmittance film device, and the lead-out electrode extends to the outside of the glass. The PET film extends between the conductive substrate and the laminating adhesive and covers the upper and lower sides of the conductive substrate simultaneously. Perform a pressing process to obtain electrochromic variable-transmittance glass.

### Embodiment 6

Place the laminating adhesive on one side of the glass. Cut a 50 μm thick PET film slightly larger than the size of the conductive tape electrode. Fix the PET film on the side of the glass opposite to the side with the laminating adhesive, corresponding to the position of the conductive tape electrode. Set the conductive tape electrode and lead-out electrode on the conductive substrate of the electrochromic variable-transmittance film device, with the lead-out electrode connected to the conductive tape electrode. Both the side of the conductive tape electrode that contacts the conductive substrate and the side opposite to it are equipped with conductive adhesive. Place the electrochromic variable-transmittance film device with the conductive tape electrode between the two glass pieces with the protective layer. The glass pieces are positioned on the sides of the electrochromic variable-transmittance film device, and the lead-out electrode extends to the outside of the glass. The PET film seals the conductive tape electrode onto the conductive substrate of the electrochromic variable-transmittance film device. Perform a pressing process to obtain electrochromic variable-transmittance glass.

### Embodiment 7

Except for replacing the 50 μm thick PET film with a 50 μm thick PI film, the rest is the same as Embodiment 1.

### Comparative Embodiment 1

Place the laminating adhesive on one side of the glass. Set the conductive tape electrode and lead-out electrode on the conductive substrate of the electrochromic variable-transmittance film device, with the lead-out electrode connected to the conductive tape electrode. Place the electrochromic variable-transmittance film device obtained above between the two glass pieces. The glass pieces are positioned on the sides of the electrochromic variable-transmittance film device, and the lead-out electrode extends to the outside of the glass. Perform a pressing process to obtain electrochromic variable-transmittance glass.

The performance parameters of each Embodiment and comparative Embodiment are shown in Table 1.

TABLE 1

| | | Initial | Coloration | Coloration |
|---|---|---|---|---|
| | Protective | Coloration | Time after | Time after |
| Embodiment | Layer | Time | 7 days | 30 days |
| Embodiment 1 | PET Film | 60 seconds | 70 seconds | 70 seconds |
| Embodiment 2 | PET Film | 60 seconds | 70 seconds | 70 seconds |
| Embodiment 3 | Epoxy Resin | 60 seconds | 72 seconds | 73 seconds |
| | Adhesive | | | |
| Embodiment 4 | Epoxy Resin | 60 seconds | 70 seconds | 70 seconds |
| | Adhesive + | | | |
| | PET Film | | | |
| Embodiment 5 | PET Film | 60 seconds | 73 seconds | 73 seconds |
| Embodiment 6 | PET Film | 60 seconds | 70 seconds | 70 seconds |
| Embodiment 7 | PI Film | 60 seconds | 200 | 1000 |
| | | | seconds | seconds |
| Comparative | — | 60 seconds | No | No |
| Embodiment 1 | | | coloration | coloration |

Note:
“—” indicates absence.

From Embodiment 1 to Embodiment 7 and Comparative Embodiment 1, it can be seen that when a protective layer is set on the conductive tape electrode, within the range of this application, the initial coloration time of the electrochromic variable-transmittance film device is the same. After 7 days and 30 days of aging, coloration can still occur, and the coloration time is shorter. This indicates that the electrochromic variable-transmittance film devices remain conductive and are in normal working condition after aging for 7 days and 30 days after lamination, solving the short-term failure issue of the electrochromic variable-transmittance film devices in electrochromic variable-transmittance glass.

The above-described embodiments are only the preferred embodiments of this application and are not intended to limit this application. Any modifications, equivalent replacements, improvements, etc., made within the spirit and principles of this application should be included within the scope of protection of this application.

1. An electrochromic variable-transmittance glass, comprising:
an electrochromic variable-transmittance film device,
at least two pieces of glass, and
laminating adhesive,
wherein:
the laminating adhesive is positioned on each opposing surface of the two pieces of glass, the electrochromic variable-transmittance film device is sandwiched between the two pieces of glass and wrapped by the laminating adhesive,
the electrochromic variable-transmittance film device comprises a conductive tape electrode, a lead-out electrode, and a protective layer,
the conductive tape electrode is positioned on a conductive substrate of the electrochromic variable-transmittance film device,
the lead-out electrode is positioned on the conductive substrate or the conductive tape electrode, conductively connected with the conductive tape electrode, and extended out of the two pieces of glass for connection to an external power source, and
the protective layer covers and seals the conductive tape electrode onto the conductive substrate.

2. The electrochromic variable-transmittance glass according to claim 1, wherein the protective layer is selected from at least one of protective film and protective adhesive, the protective film being one of polyethylene terephthalate film, polyimide film, polypropylene film, polyethylene film, or epoxy resin film, and the protective adhesive being one of epoxy resin, UV-curable adhesive, two-component mixed-curing adhesive, conductive silver adhesive, or conductive copper adhesive.

3. The electrochromic variable-transmittance glass according to claim 1, wherein the thickness of the protective layer is between 10 micrometers to 1000 micrometers.

4. The electrochromic variable-transmittance glass according to claim 1, wherein at least one end of the conductive tape electrode includes conductive glue.

5. The electrochromic variable-transmittance glass according to claim 1, wherein the protective layer is selected from protective film or protective adhesive, wherein the protective adhesive covers and seals the conductive tape electrodes a onto the conductive substrate, and the protective film covers the protective adhesive.

6. The electrochromic variable-transmittance glass according to claim 5, wherein the electrochromic variable-transmittance film device is sandwiched between conductive substrates on both upper and lower sides, the protective film extending between the conductive substrates and the laminating adhesive, and covering portions of the upper and lower sides of the conductive substrates.

7. A manufacturing method for the electrochromic variable-transmittance glass comprising an electrochromic variable-transmittance film device, at least two pieces of glass, a conductive substrate, and laminating adhesive, wherein the method comprises:
(1) placing the laminating adhesive on one side of each of the two pieces of glass;
(2) placing a conductive tape electrode on the conductive substrate of the electrochromic variable-transmittance film device, placing a lead-out electrode on the conductive substrate or the conductive tape electrode, and establishing conductive connection between the lead-out electrode and the conductive tape electrode;
(3) setting a protective layer on the conductive tape electrode, covering and sealing the conductive tape electrode onto the conductive substrate;
(4) placing the electrochromic variable-transmittance film device with the protective layer between the two pieces of glass obtained in step (1), with the sides of the laminating adhesive opposing each other, and pressing the two pieces of glass obtained in step (1) to obtain the electrochromic variable-transmittance glass, wherein the lead-out electrode extends out of the two pieces of glass.

8. The manufacturing method according to claim 7, wherein the protective layer is selected from a protective film, the protective film being one of polyethylene terephthalate film, polyimide film, polypropylene film, polyethylene film, or epoxy resin film, and the protective film is directly set on the conductive tape electrode.

9. The manufacturing method according to claim 7, wherein the protective layer is selected from the protective film, the protective film being one of polyethylene terephthalate film, polyimide film, polypropylene film, polyethylene film, or epoxy resin film, wherein conductive glue is placed on both sides of the conductive tape electrode, and the protective film is pre-fixed on the conductive tape electrode.

10. The manufacturing method according to claim 7, wherein the protective layer is selected from protective adhesive, the protective adhesive being one of epoxy resin, UV-curable adhesive, two-component mixed-curing adhesive, conductive silver adhesive, or conductive copper adhesive, wherein the protective adhesive covers the conductive tape electrode in a point-by-point manner, and seals the conductive tape electrode onto the conductive substrate.

11. The manufacturing method according to claim 7, wherein the protective layer is selected from the protective film, the protective adhesive being one of epoxy resin, UV-curable adhesive, two-component mixed-curing adhesive, conductive silver adhesive, or conductive copper adhesive, wherein the protective film is pre-fixed on the side of the two pieces of glass with laminating adhesive, corresponding to the position of the conductive tape electrode.
